(19) United States
(12) Patent Application Publication
(10) Pub. No.: US 2025/0155090 A1
(43) Pub. Date: May 15, 2025

(54) VENTING SYSTEM AND VENTING METHOD

(71) Applicant: NIPPON TELEGRAPH AND TELEPHONE CORPORATION, Tokyo (JP)

(72) Inventors: Takuya ISHIKAWA, Tokyo (JP); Koji ITASAKA, Tokyo (JP); Akira ITO, Tokyo (JP)

(73) Assignee: NIPPON TELEGRAPH AND TELEPHONE CORPORATION, Tokyo (JP)

(21) Appl. No.: 18/840,041

(22) PCT Filed: Feb. 21, 2022
(86) PCT No.: PCT/JP2022/007017

§ 371 Date: Aug. 20, 2024

(51) Int. Cl. F17D 5/02; F17D 5/00

(52) U.S. Cl. CPC F17D 5/02; F17D 5/005

(57) ABSTRACT

According to the present disclosure, a vent system (1) includes a supply-side inert gas tank (11) that supplies an inert gas, an inert gas transmission pipe (13) that transmits the inert gas, the inert gas transmission pipe having a gas transport pipeline disposed inside, and a recovery-side inert gas tank (12) that recovers the transmitted inert gas.

### TECHNICAL FIELD

The present disclosure relates to a vent system and a venting method.

### BACKGROUND ART

In recent years, a method of supplying a hydrogen gas and safety in supplying the hydrogen gas have been studied in order to utilize the hydrogen gas for realizing carbon neutral for decarbonization. For example, Non Patent Literature 1 discloses that a hydrogen pipeline for transporting hydrogen is supplied, and a detector detects leaked hydrogen.

### CITATION LIST

### Non Patent Literature

Non Patent Literature 1: Tetsuji MORITA, “Current Approaches by the City Gas Industry to Supply Hydrogen Through the Pipelines”, The Institute of Electrical Installation Engineers of Japan, The Journal of the Institute of Electrical Installation Engineers of Japan 36(4) 242-245, 2016

### SUMMARY OF INVENTION

### Technical Problem

However, in the conventional technique, as illustrated in FIG. 7, in an underground space S1, hydrogen may leak from a hydrogen pipeline 93 that supplies hydrogen from a supply-side hydrogen tank 91 to a consumption-side hydrogen tank 92. The underground space S1 is a space defined by a manhole 94 or the like provided in the underground A. In addition, hydrogen may also leak from the hydrogen pipeline 93 in a pipe 95 that causes underground spaces S1 to communicate with each other. In such a case, the leaked hydrogen has been diffused to the outside of the underground space S1 by natural diffusion. Since natural diffusion of hydrogen takes time, there has been a risk of filling the underground space S1 with hydrogen, resulting in an occurrence of an explosion in the underground space S1.

An object of the present disclosure made in view of such circumstances is to provide a vent system and a venting method for discharging a gas that has been leaked from a gas transport pipeline to a ground space without filling an underground space with the leaked gas.

### Solution to Problem

In order to solve the above problems, a vent system according the present disclosure includes a supply-side inert gas tank that supplies an inert gas, an inert gas transmission pipe that transmits the inert gas, the inert gas transmission pipe having a gas transport pipeline disposed inside, and a recovery-side inert gas tank that recovers the transmitted inert gas.

Further, in order to solve the above problems, a venting method according to the present disclosure is performed by a vent system including a supply-side inert gas tank, an inert gas transmission pipe having a gas transport pipeline disposed inside, and a recovery-side inert gas tank. The venting method includes a step of supplying an inert gas by the supply-side inert gas tank, a step of transmitting the inert gas by the inert gas transmission pipe, and a step of recovering the transmitted inert gas by the recovery-side inert gas tank.

### Advantageous Effects of Invention

According to the vent system and the venting method according to the present disclosure, it is possible to discharge a gas that has been leaked from a gas transport pipeline to a ground space without filling an underground space with the gas.

### BRIEF DESCRIPTION OF DRAWINGS

FIG. 1 is a schematic diagram of a vent system according to the present embodiment of the present disclosure.

FIG. 2A is a schematic diagram illustrating a half pipe forming a part of an inert gas transmission pipe illustrated in FIG. 1.

FIG. 2B is a schematic diagram illustrating a part of the inert gas transmission pipe formed by fitting the half pipe illustrated in FIG. 2A.

FIG. 3 is a diagram for describing a fixing portion illustrated in FIG. 1 in detail.

FIG. 4 is a functional block diagram of a determination device illustrated in FIG. 1.

FIG. 5 is a sequence diagram illustrating a process for constructing the vent system.

FIG. 6 is a sequence diagram illustrating an operation of a vent system.

FIG. 7 is a schematic diagram for describing a conventional underground space in which a gas transport pipeline is provided.

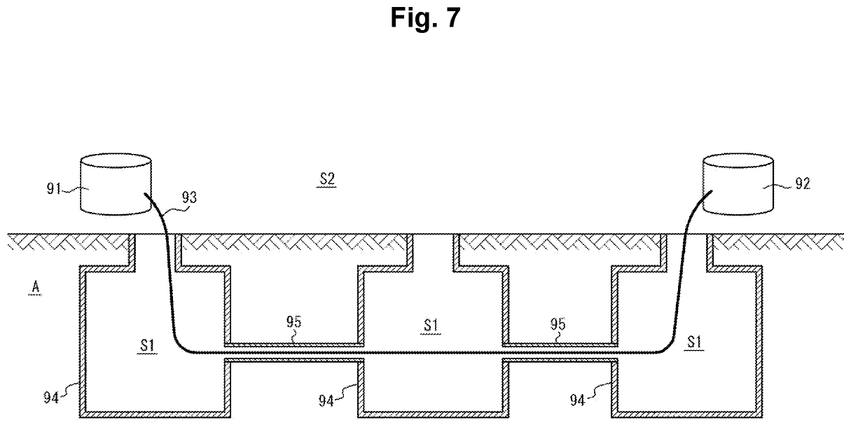

### DESCRIPTION OF EMBODIMENTS

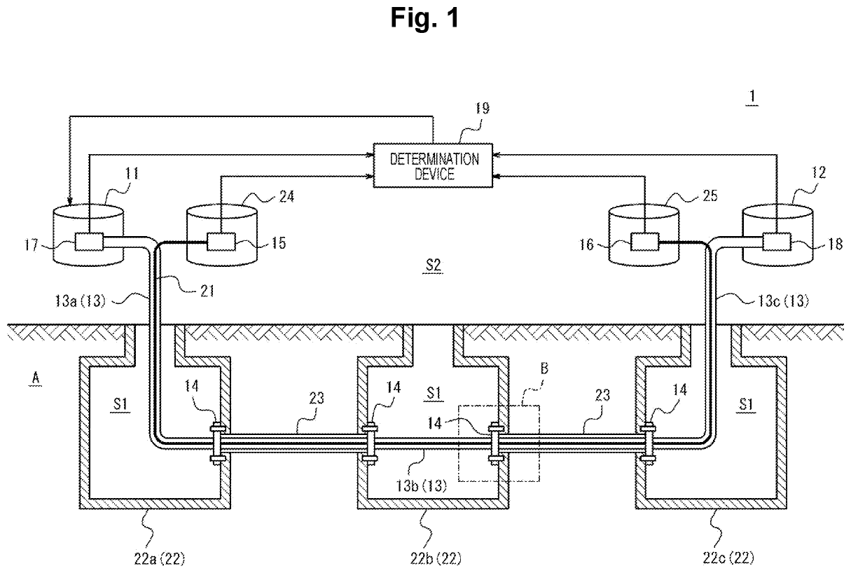

An overall configuration of the present embodiment will be described with reference to FIG. 1. FIG. 1 is a schematic diagram of a vent system 1 according to the present embodiment.

As illustrated in FIG. 1, the vent system 1 according to the present embodiment is a system that discharges a gas that has been leaked from a gas transport pipeline 21 disposed in an underground space S1. The underground space S1 is a space defined by an underground structure 22 such as a manhole, a tunnel, or a handhole provided in the underground A. In the example illustrated in FIG. 1, three underground structures 22a to 22c are provided in the underground space S1. A pipeline 23 is attached to the underground structure 22, and a plurality of underground spaces S1 communicates with each other by the pipeline 23. It is preferable that the pipeline 23 have high airtightness such that, when a gas has been leaked from the gas transport pipeline 21 disposed inside, further leakage of the gas to the outside of the pipeline 23 is suppressed.

The gas transport pipeline 21 is a pipeline that transports a gas from a supply-side gas tank 24 disposed in a ground space S2 to a consumption-side gas tank 25. In the present embodiment, the gas is hydrogen, and the gas transport pipeline 21 is a hydrogen pipeline, but the present disclosure is not limited thereto.

Specifically, one end of the gas transport pipeline 21 is provided in a supply port of the supply-side gas tank 24 so that the gas supplied from the supply-side gas tank 24 is received in the gas transport pipeline 21. The other end of the gas transport pipeline 21 is provided at a reception port of the consumption-side gas tank 25 so that the gas transported through the gas transport pipeline 21 flows into the consumption-side gas tank 25. That is, the gas transport pipeline 21 extends from the supply port of the supply-side gas tank 24 to the reception port of the consumption-side gas tank 25 through the underground space S1 and the pipeline 23.

The vent system 1 includes a supply-side inert gas tank 11, a recovery-side inert gas tank 12, an inert gas transmission pipe 13, a fixing portion 14, a supply-side gas pressure gauge 15, a consumption-side gas pressure gauge 16, a supply-side inert gas pressure gauge 17, a recovery-side inert gas pressure gauge 18, and a determination device 19.

The supply-side inert gas tank 11 supplies an inert gas. Specifically, the supply-side inert gas tank 11 pumps the inert gas to the inert gas transmission pipe 13 by using a pump or the like. For example, the supply-side inert gas tank 11 may supply an inert gas when it is determined that the gas is leaked from the gas transport pipeline 21. Specifically, when the determination device 19 to be described later in detail determines that the gas is leaked, a control command for controlling the supply-side inert gas tank 11 to supply the inert gas is output. Then, the supply-side inert gas tank 11 supplies the inert gas by being controlled based on the control command. The inert gas is a gas that is chemically stable and does not easily react with other elements or with other compounds. The inert gas can be, for example, nitrogen, helium, neon, argon, krypton, xenon, radon, carbon dioxide, or the like. The supply-side inert gas tank 11 may be disposed in the ground space S2.

The recovery-side inert gas tank 12 recovers the inert gas transmitted by the inert gas transmission pipe 13. As a result, when a gas is leaked from the gas transport pipeline 21, the recovery-side inert gas tank 12 recovers the gas that has been leaked from the gas transport pipeline 21, which is transmitted together with the inert gas by the inert gas transmission pipe 13. The recovery-side inert gas tank 12 may be disposed in the ground space S2.

The inert gas transmission pipe 13 has the gas transport pipeline 21 disposed inside, and transmits an inert gas. Specifically, the inert gas transmission pipe 13 is provided to transmit the inert gas from the supply-side inert gas tank 11 to the recovery-side inert gas tank 12 via the pipeline 23. In the example illustrated in FIG. 1, the inert gas transmission pipe 13 includes inert gas transmission pipes 13a to 13c.

One end of the inert gas transmission pipe 13a is connected to a supply port of the supply-side inert gas tank 11, and is provided such that the gas supplied from the supply-side inert gas tank 11 is supplied to the inert gas transmission pipe 13. In addition, the other end of the inert gas transmission pipe 13a is connected to the pipeline 23 attached to the underground structure 22a. In addition, one end of the inert gas transmission pipe 13b is connected to the pipeline 23 that causes the interiors of the underground structure 22a and the underground structure 22b to communicate with each other. The other end of the inert gas transmission pipe 13b is connected to the pipeline 23 that causes the interiors of the underground structure 22b and the underground structure 22c to communicate with each other. Further, one end of the inert gas transmission pipe 13c is connected to the pipeline 23 attached to the underground structure 22c. In addition, the other end of the inert gas transmission pipe 13c is connected to a reception port of the recovery-side inert gas tank 12, and is provided such that the inert gas transmitted through the inert gas transmission pipe 13c flows into the recovery-side inert gas tank 12 through the reception port. As a result, the inert gas supplied to the inert gas transmission pipe 13 by the supply-side inert gas tank 11 is transmitted to the recovery-side inert gas tank 12 through the inert gas transmission pipe 13 and the pipeline 23.

The inert gas transmission pipe 13 may be a flexible pipe. The flexible pipe is a pipe of which the size and shape are variable, and can be set to, for example, a bellows pipe. As a result, even when the gas transport pipeline 21 is bent or folded, the gas transport pipeline may be disposed inside the inert gas transmission pipe 13.

The inert gas transmission pipe 13 is formed of a material that can withstand a pressure transmission force (for example, 0.95 MpA) of the inert gas transmitted in the inert gas transmission pipe 13. Such a material can be set to, for example, a stainless steel material (SUS: Steel Use Stainless). In addition, the diameter of the inert gas transmission pipe 13 may be, for example, equal to the diameter of the pipeline 23 (the diameter of a general pipeline 23 is 75 mm). In such a configuration, it is possible to suppress leakage of the gas at a portion where the inert gas transmission pipe 13 and the pipeline 23 are connected to each other.

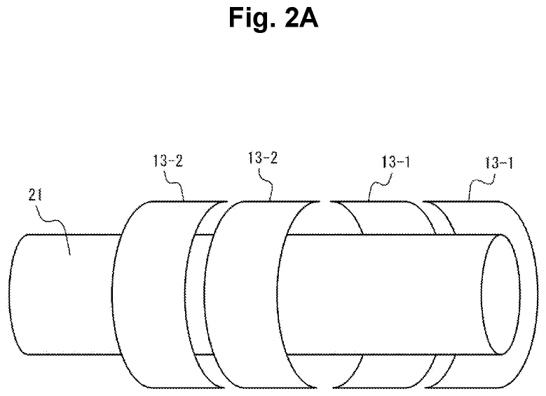

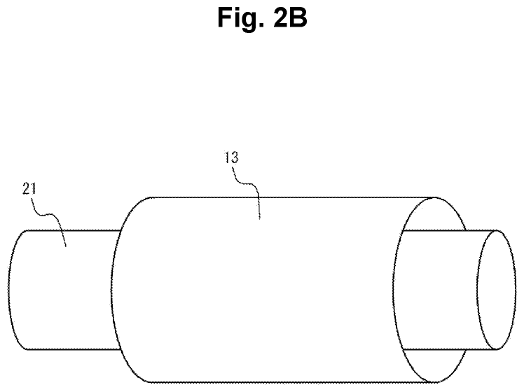

As illustrated in FIG. 2A, the inert gas transmission pipe 13 may be formed by a plurality of half pipes 13-1 and 13-2 fitted to each other. For example, in a state where the half pipe 13-1 and the half pipe 13-2 facing each other face each other in the radial direction of the gas transport pipeline 21, the half pipe 13-1 and the half pipe 13-2 are fit with each other. Further, a plurality of combinations of the half pipes 13-1 and the half pipes 13-2 fit with each other are fit with each other to be connected to each other in an extension direction of the gas transport pipeline 21. In this manner, the inert gas transmission pipe 13 having the gas transport pipeline 21 disposed inside is formed, as illustrated in FIG. 2B. Note that a fitting portion formed in each of the half pipes 13-1 and 13-2 in order for the plurality of half pipes 13-1 and 13-2 to be fitted to each other may have any shape. Therefore, the detailed description of the fitting portion will be omitted in FIG. 2A.

Further, the half pipe 13-1 and the half pipe 13-2 may be bonded to each other by welding. As a result, it is possible to improve sealability of the inert gas transmission pipe 13 and to suppress an occurrence of a situation in which the gas leaked from the gas transport pipeline 21 is leaked to the outside of the inert gas transmission pipe 13. Further, the plurality of combinations of the half pipes 13-1 and the half pipes 13-2 that are adjacent in the extension direction of the gas transport pipeline 21 and are fit with each other may be bonded by welding. As a result, it is possible to further improve the sealability of the inert gas transmission pipe 13.

By forming the inert gas transmission pipe 13 in this manner, the gas supplied from the supply-side inert gas tank 11 is transmitted to the recovery-side inert gas tank 12 through the outside of the gas transport pipeline 21 disposed in the inert gas transmission pipe 13, which is on the inside of the inert gas transmission pipe 13. At this time, when the gas is leaked from the gas transport pipeline 21, the gas leaked from the gas transport pipeline 21 is transmitted to the recovery-side inert gas tank 12 together with the inert gas without being leaked to the outside of the inert gas transmission pipe 13.

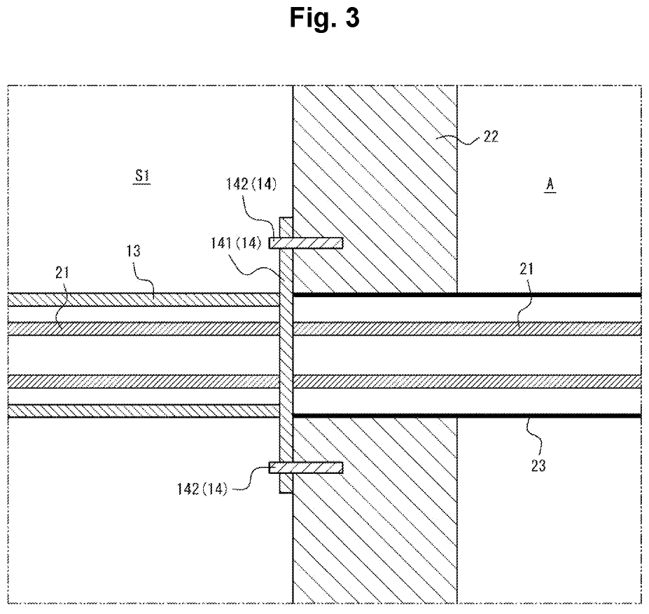

FIG. 3 is an enlarged view of the inside of a rectangle B indicated by a one-dot chain line in FIG. 1. As illustrated in FIG. 3, the fixing portion 14 includes a duct connection port 141 and an anchor 142.

The duct connection port 141 is a member that is attached to the end of the inert gas transmission pipe 13 and is attached to the underground structure 22 in a state where the end of the inert gas transmission pipe 13 is attached. For example, the duct connection port 141 may be formed by a flat plate having a circular hole. The diameter of the hole can be set to be substantially equal to the inner diameter of the inert gas transmission pipe 13. The end of the inert gas transmission pipe 13 is crimped and attached to one surface of the duct connection port 141 such that the flat hole forming the duct connection port 141 communicates with the inside of the inert gas transmission pipe 13.

The anchor 142 is a member that fixes, to the underground structure 22, the duct connection port 141 to which the end portion of the inert gas transmission pipe 13 is attached. For example, the anchor 142 may be inserted from the side of one surface of the duct connection port 141 into the wall of the underground structure 22 in a state where the other surface of the duct connection port 141 is crimped to the inner wall of the underground structure 22. At this time, a plurality of anchors 142 may be inserted into the wall surface of the manhole from the side of one surface of the duct connection port 141. As a result, it is possible to suppress an occurrence of deformation or the like in the duct connection port 141 due to the pressure of the inert gas transmitted by the inert gas transmission pipe 13.

The supply-side gas pressure gauge 15 measures the internal pressure of the supply-side gas tank 24. The internal pressure of the supply-side gas tank 24 may be the pressure of the gas at the supply port of the supply-side gas tank 24.

The consumption-side gas pressure gauge 16 measures the internal pressure of the consumption-side gas tank 25. The internal pressure of the consumption-side gas tank 25 may be the pressure of the gas at the reception port of the consumption-side gas tank 25.

The supply-side inert gas pressure gauge 17 measures the internal pressure of the supply-side inert gas tank 11. The internal pressure of the supply-side inert gas tank 11 may be the pressure of the gas at the supply port of the supply-side inert gas tank 11.

The recovery-side inert gas pressure gauge 18 measures the internal pressure of the recovery-side inert gas tank 12. The internal pressure of the recovery-side inert gas tank 12 may be the pressure of the gas at the reception port of the recovery-side inert gas tank 12.

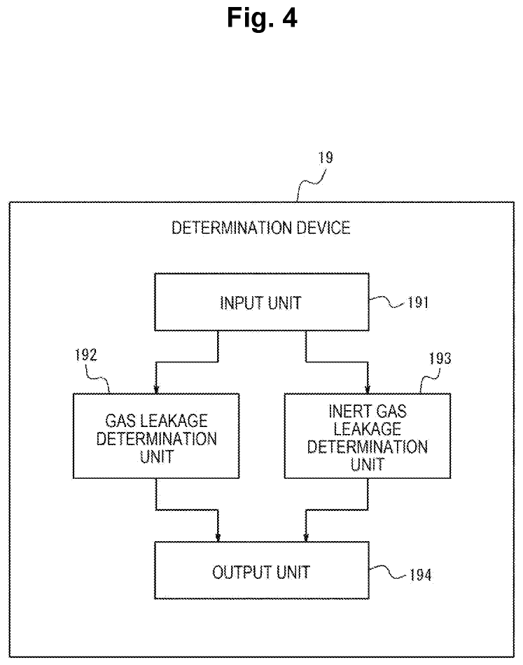

As illustrated in FIG. 4, the determination device 19 includes an input unit 191, a gas leakage determination unit 192, an inert gas leakage determination unit 193, and an output unit 194. The input unit 191 can be configured by an input interface that receives an input of information. The input unit 191 may receive an input of information by an operation of a user using a pointing device, a keyboard, a mouse, a touch panel, or the like, or may receive an input of information received from an external device. The gas leakage determination unit 192 and the inert gas leakage determination unit 193 can be configured by a controller. The controller may be configured by dedicated hardware such as an application specific integrated circuit (ASIC) or a field-programmable gate array (FPGA), may be configured by a processor, or may be configured to include both. The output unit 194 can be configured by an output interface that outputs information.

The input unit 191 receives inputs of supply-side gas tank internal pressure information and consumption-side gas tank internal pressure information. The supply-side gas tank internal pressure information indicates the internal pressure of the supply-side gas tank 24 measured by the supply-side gas pressure gauge 15. The consumption-side gas tank internal pressure information indicates the internal pressure of the consumption-side gas tank 25 measured by the consumption-side gas pressure gauge 16. In addition, the input unit 191 may receive inputs of supply-side inert gas tank internal pressure information and recovery-side inert gas tank internal pressure information. The supply-side inert gas tank internal pressure information indicates the internal pressure of the supply-side inert gas tank 11 measured by the supply-side inert gas pressure gauge 17. The recovery-side inert gas tank internal pressure information indicates the internal pressure of the recovery-side inert gas tank 12 measured by the recovery-side inert gas pressure gauge 18.

The gas leakage determination unit 192 determines whether or not the gas is leaked from the gas transport pipeline 21 based on the internal pressure of the supply-side gas tank 24 that supplies the gas to the gas transport pipeline 21 and the internal pressure of the consumption-side gas tank 25 that receives the gas transported by the gas transport pipeline 21. Specifically, the gas leakage determination unit 192 calculates a difference of the internal pressure of the supply-side gas tank 24 from the internal pressure of the consumption-side gas tank 25, and determines whether or not the difference is equal to or more than a gas difference threshold value. Then, when determining that the difference is equal to or more than the gas difference threshold value, the gas leakage determination unit 192 determines that the gas is leaked. When determining that the difference is less than the gas difference threshold value, the gas leakage determination unit 192 determines that the gas is not leaked.

The inert gas leakage determination unit 193 determines whether or not the inert gas is leaked from the inert gas transmission pipe 13 based on the internal pressure of the supply-side inert gas tank 11 and the internal pressure of the recovery-side inert gas tank 12. Specifically, the inert gas leakage determination unit 193 calculates a difference of the internal pressure of the supply-side inert gas tank 11 from the internal pressure of the recovery-side inert gas tank 12, and determines whether or not the difference is equal to or more than an inert gas difference threshold value. Then, the inert gas leakage determination unit 193 determines that the inert gas is leaked when determining that the difference is equal to or more than the inert gas difference threshold value, and determines that the inert gas is not leaked when determining that the difference is less than the inert gas difference threshold value.

When the gas leakage determination unit 192 determines that the gas is leaked, the output unit 194 outputs a control command for controlling the supply-side inert gas tank 11 to supply the inert gas, to the supply-side inert gas tank 11. When the gas leakage determination unit 192 determines that the gas is leaked, the output unit 194 may output information indicating the leakage of the gas to a display device configured by an organic electro luminescence (EL), a liquid crystal panel, or the like, or another device. The output unit 194 may output, to a display device or another device, information indicating whether or not the gas is leaked, which is obtained by the determination of the gas leakage determination unit 192.

When the inert gas leakage determination unit 193 determines that the inert gas is leaked, the output unit 194 may output information indicating leakage of the inert gas to a display device or another device. The output unit 194 may output, to a display device or another device, information indicating whether or not the inert gas is leaked, which is obtained by the determination of the inert gas leakage determination unit 193.

### <Construction of Vent System>

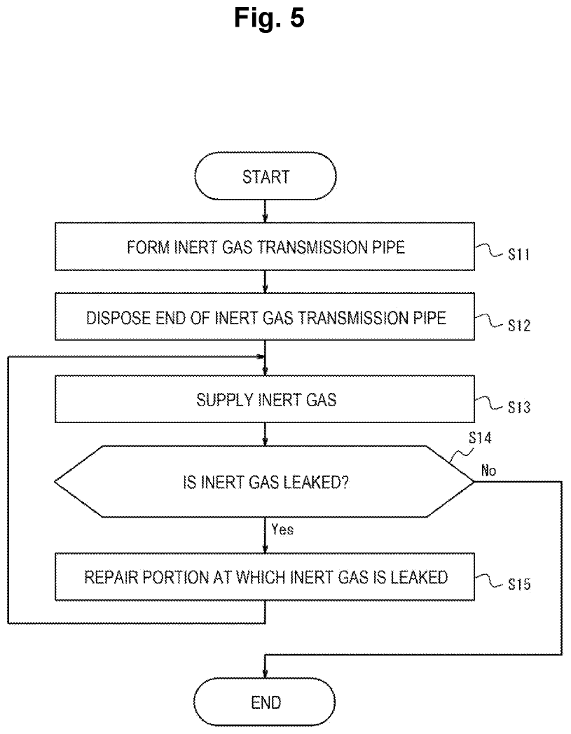

Here, a process of constructing the vent system 1 according to the present embodiment will be described with reference to FIG. 5. FIG. 5 is a sequence diagram illustrating an example of the process of constructing the vent system 1 according to the present embodiment.

In step S11, an inert gas transmission pipe 13 is formed. Specifically, a half pipe 13-1 and a half pipe 13-2 are fitted to each other in a state where the half pipe 13-1 and the half pipe 13-2 facing each other face each other in the radial direction of the gas transport pipeline 21. Then, the plurality of combinations of the half pipes 13-1 and the half pipes 13-2 fit with each other are fitted with each other to be connected in the extension direction of the gas transport pipeline 21. Further, the half pipe 13-1 and the half pipe 13-2 may be bonded to each other by welding, or the combinations of the plurality of half pipes 13-1 and half pipes 13-2 fit with each other may be bonded to each other by welding.

In step S12, an end of the inert gas transmission pipe 13 is disposed. In the example illustrated in FIG. 1, an end of an inert gas transmission pipe 13a on the supply-side inert gas tank 11 side is connected to the supply port of the inert gas tank 11. In addition, the opposite end of the inert gas transmission pipe 13a is attached to the duct connection port 141 by crimping, and the duct connection port 141 is fixed to the underground structure 22a. Further, one end of an inert gas transmission pipe 13b is connected to one pipeline port of the underground structure 22b, and the other end of the inert gas transmission pipe 13b is connected to the other pipeline port of the underground structure 22b. In addition, an end of an inert gas transmission pipe 13c on the recovery-side inert gas tank 12 side is connected to the reception port of the recovery-side inert gas tank 12. In addition, the opposite end of the inert gas transmission pipe 13c is attached to the duct connection port 141 by crimping, and the duct connection port 141 is fixed to the underground structure 22c.

In step S13, an inert gas is supplied from the supply-side inert gas tank 11 to the inert gas transmission pipe 13.

In step S14, it is determined whether or not the inert gas is leaked from the inert gas transmission pipe 13.

When it is determined in step S14 that the inert gas is leaked from the inert gas transmission pipe 13, in step S15, the transmission of the inert gas is stopped, and a portion at which the inert gas is leaked in the inert gas transmission pipe 13 is repaired (re-formed or re-disposed). Then, the process returns to step S13.

When it is determined in step S14 that the inert gas is not leaked from the inert gas transmission pipe 13, the process of constructing the vent system 1 is ended.

When it is determined in step S14 that the inert gas is not leaked from the inert gas transmission pipe 13, it may be determined whether or not the gas is leaked from the gas transport pipeline 21. When it is determined that the gas is leaked from the gas transport pipeline 21, a portion at which the gas is leaked in the gas transport pipeline 21 may be repaired.

### <Operation of Determination Device>

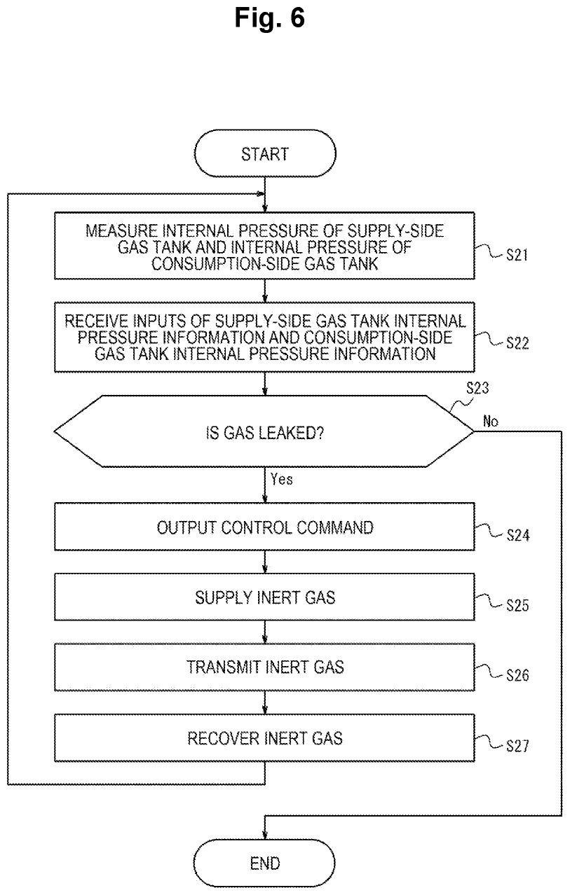

Subsequently, the operation of the vent system 1 according to the present embodiment will be described with reference to FIG. 6. FIG. 6 is a sequence diagram illustrating an example of the operation in the vent system 1 according to the present embodiment. The operation in the vent system 1 described with reference to FIG. 6 corresponds to a venting method performed by the vent system 1 according to the present embodiment. Further, the vent system 1 performs the operation when the supply-side gas tank 24 supplies a gas to the gas transport pipeline 21. The vent system 1 can start the operation at any timing. For example, the vent system 1 may start the operation at predetermined time intervals, may start the operation by an operation of an administrator or a command received from an external device, or may start the operation again after the operation is ended.

In step S21, the supply-side gas pressure gauge 15 measures the internal pressure of the supply-side gas tank 24, and the consumption-side gas pressure gauge 16 measures the internal pressure of the consumption-side gas tank 25.

In step S22, the determination device 19 receives an input of supply-side gas tank internal pressure information indicating the internal pressure of the supply-side gas tank 24 measured by the supply-side gas pressure gauge 15. In addition, the determination device 19 receives an input of consumption-side gas tank internal pressure information indicating the internal pressure of the consumption-side gas tank 25 measured by the consumption-side gas pressure gauge 16.

In step S23, the determination device 19 determines whether or not the gas is leaked from the gas transport pipeline 21 based on the internal pressure of the supply-side gas tank 24 indicated by the supply-side gas tank internal pressure information and the internal pressure of the consumption-side gas tank 25 indicated by the consumption-side gas tank internal pressure information. When it is determined in step S23 that the gas is not leaked from the gas transport pipeline 21, the vent system 1 ends the process.

When it is determined in step S23 that the gas is leaked from the gas transport pipeline 21, in step S24, the determination device 19 outputs a control command for controlling the supply-side inert gas tank 11 to supply the inert gas.

In step S25, the supply-side inert gas tank 11 supplies the inert gas based on the control command.

In step S26, the inert gas transmission pipe 13 transmits the inert gas.

In step S27, the recovery-side inert gas tank 12 recovers the inert gas transmitted in step S26. Thereafter, the vent system 1 causes the process to return to step S21 and repeats the process.

In addition, when it is determined in step S23 that the gas is leaked from the gas transport pipeline 21, the determination device 19 may output information indicating the leakage of the gas to the display device or another device. As a result, the manager of the gas transport pipeline 21 can recognize that it is necessary to repair the gas transport pipeline 21. In addition, before the manager enters into the underground space S1 to repair the gas transport pipeline 21, the determination device 19 may determine whether or not the gas is leaked from the gas transport pipeline 21 and determine whether or not the inert gas is leaked from the inert gas transmission pipe 13. As a result, the administrator can recognize whether or not the gas is leaked from the gas transport pipeline 21 and the inert gas transmission pipe 13, and can enter into the underground space S1 after confirming safety.

As described above, according to the present embodiment, the vent system 1 includes the supply-side inert gas tank 11 that supplies the inert gas, the inert gas transmission pipe 13 that transmits the inert gas, the inert gas transmission pipe having a gas transport pipeline 21 disposed inside, and the recovery-side inert gas tank 12 that recovers the transmitted inert gas. As a result, when the gas is leaked from the gas transport pipeline 21, the vent system 1 can discharge the leaked gas together with the inert gas without filling the underground space S1 with the leaked gas. In particular, the supply-side inert gas tank 11 pumps the inert gas to the inert gas transmission pipe 13, whereby it is possible to more effectively discharge the gas that has been leaked from the gas transport pipeline 21. Therefore, it is possible to suppress filling of the underground space S1 with the leaked gas. Accordingly, it is possible to suppress the occurrence of the risk of an explosion occurring in the underground space S1 due to the filling of the underground space S1 with hydrogen. Thus, a worker can safely enter into the underground space S1, for example, in order to repair the equipment in the underground space S1.

Further, according to the present embodiment, the supply-side inert gas tank 11 may supply the inert gas when it is determined that the gas is leaked from the gas transport pipeline 21. As a result, the supply-side inert gas tank 11 does not normally supply the inert gas but supplies the gas when it is determined that the gas is leaked. Thus, it is possible to discharge the leaked gas from the underground space S1 while reducing the use of the inert gas.

Further, according to the present embodiment, the vent system 1 may further include the determination device 19 that determines whether or not the gas is leaked from the gas transport pipeline 21 based on the internal pressure of the supply-side gas tank 24 that supplies the gas to the gas transport pipeline 21 and the internal pressure of the consumption-side gas tank 25 that receives the gas transmitted by the gas transport pipeline 21. As a result, the worker can safely determine whether or not the gas is leaked without installing a gas detector in a place where the gas may be leaked.

Further, according to the present embodiment, the determination device 19 may determine whether or not the inert gas is leaked from the inert gas transmission pipe 13 based on the internal pressure of the supply-side inert gas tank 11 and the internal pressure of the recovery-side inert gas tank 12. As a result, the worker can recognize the leakage of the inert gas, and can repair the inert gas transmission pipe 13 as appropriate. Accordingly, when the gas has been leaked from the gas transport pipeline 21, it is possible to reliably discharge the leaked gas together with the inert gas without filling the underground space S1.

Regarding the above embodiment, the following supplementary notes are further disclosed.

### Supplement 1

A vent system including:
a supply-side inert gas tank that supplies an inert gas;
an inert gas transmission pipe that transmits the inert gas, the inert gas transmission pipe having a gas transport pipeline disposed inside; and
a recovery-side inert gas tank that recovers the transmitted inert gas.

### Supplement 2

The vent system according to Supplement 1, in which the supply-side inert gas tank supplies the inert gas when it is determined that a gas is leaked from the gas transport pipeline.

### Supplement 3

The vent system according to Supplement 2, further including:
a controller that determines whether or not a gas is leaked from the gas transport pipeline based on an internal pressure of a supply-side gas tank that supplies a gas to the gas transport pipeline and an internal pressure of a consumption-side gas tank that receives the gas transported by the gas transport pipeline.

### Supplement 4

The vent system according to Supplement 3, in which the controller determines whether or not the inert gas is leaked from the inert gas transmission pipe based on an internal pressure of the supply-side inert gas tank and an internal pressure of the recovery-side inert gas tank.

### Supplement 5

A venting method performed by a vent system including a supply-side inert gas tank, an inert gas transmission pipe having a gas transport pipeline disposed inside, and a recovery-side inert gas tank, the venting method including:
supplying an inert gas by the supply-side inert gas tank;
transmitting the inert gas by the inert gas transmission pipe; and
recovering the transmitted inert gas by the recovery-side inert gas tank.

All the literatures, patent applications, and techniques mentioned in this specification are incorporated herein by reference to the same extent as if each individual literature, patent application, and technical technique were specifically and individually described to be incorporated by reference.

Although the above-described embodiment has been described as the representative example, it is apparent to those skilled in the art that many modifications and substitutions can be made within the spirit and scope of the present disclosure. Accordingly, it should not be understood that the present invention is limited by the above embodiment, and various modifications or changes can be made within the scope of the claims.

### REFERENCE SIGNS LIST

1 Vent system
11 Supply-side inert gas tank
12 Recovery-side inert gas tank
13, 13a, 13b, 13c Inert gas transmission pipe
13-1, 13-2 Half pipe
14 Fixing portion
15 Supply-side gas pressure gauge
16 Consumption-side gas pressure gauge
17 Supply-side inert gas pressure gauge
18 Recovery-side inert gas pressure gauge
19 Determination device
21 Gas transport pipeline
22, 22a, 22b, 22c Underground structure
23 Pipeline
24 Supply-side gas tank
25 Consumption-side gas tank
141 Duct connection port
142 Anchor
191 Input unit
192 Gas leakage determination unit
193 Inert gas leakage determination unit
194 Output unit
A Underground
S1 Underground space
S2 Ground space

1. A vent system comprising:
a supply-side inert gas tank that supplies an inert gas;
an inert gas transmission pipe that transmits the inert gas, the inert gas transmission pipe having a gas transport pipeline disposed inside; and
a recovery-side inert gas tank that recovers the transmitted inert gas.

2. The vent system according to claim 1, wherein the supply-side inert gas tank supplies the inert gas when it is determined that a gas is leaked from the gas transport pipeline.

3. The vent system according to claim 2, further comprising:
a determination device that determines whether or not a gas is leaked from the gas transport pipeline based on an internal pressure of a supply-side gas tank that supplies a gas to the gas transport pipeline and an internal pressure of a consumption-side gas tank that receives the gas transported by the gas transport pipeline.

4. The vent system according to claim 3, wherein the determination device determines whether or not the inert gas is leaked from the inert gas transmission pipe based on an internal pressure of the supply-side inert gas tank and an internal pressure of the recovery-side inert gas tank.

5. A venting method performed by a vent system including a supply-side inert gas tank, an inert gas transmission pipe having a gas transport pipeline disposed inside, and a recovery-side inert gas tank, the venting method comprising:
supplying an inert gas by the supply-side inert gas tank;
transmitting the inert gas by the inert gas transmission pipe; and
recovering the transmitted inert gas by the recovery-side inert gas tank.

6. The venting method according to claim 5, wherein the supply-side inert gas tank supplies the inert gas when it is determined that a gas is leaked from the gas transport pipeline.

7. The venting method according to claim 6, further comprising:
determining, whether or not a gas is leaked from the gas transport pipeline, based on an internal pressure of a supply-side gas tank that supplies a gas to the gas transport pipeline and an internal pressure of a consumption-side gas tank that receives the gas transported by the gas transport pipeline.

8. The venting method according to claim 7, further comprising:
determining, whether or not the inert gas is leaked from the inert gas transmission pipe, based on an internal pressure of the supply-side inert gas tank and an internal pressure of the recovery-side inert gas tank.

9. The vent system according to claim 1, wherein the inert gas transmission pipe is formed by fitting together a plurality of half-pipes, wherein each of the plurality of half-pipes is facing each other in a radial direction of the gas transport pipeline.

10. The vent system according to claim 9, wherein the plurality of half-pipes that is fitted is extending in a direction of the gas transport pipeline.

11. The vent system according to claim 1, wherein one end of the inert gas transmission pipe is connected to a supply port of the supply-side inert gas tank and other end is connected to a duct connection port that is fixed to an underground structure.

12. The vent system according to claim 1, wherein the vent system further comprising a controller that configures a gas leakage determination unit and an inert gas leakage determination unit.
